(19) United States
(12) Patent Application Publication
(10) Pub. No.: US 2010/0299181 A1
(43) Pub. Date: Nov. 25, 2010

(54) Management of inventory allocations

(75) Inventors: Andrew Loch, Queensland (AU); Helen Johnson, Queensland (AU); Geoffrey Toogood, Queensland (AU); Daniel Paul Ruul, Queensland (AU)

Correspondence Address: SCHWEGMAN, LUNDBERG & WOESSNER, P.A., P.O. BOX 2938, MINNEAPOLIS, MN, 55402, US

(73) Assignee: Allotz.com Limited, Bundall, QLD (AU)

(21) Appl. No.: 12/227,451

(22) PCT Filed: May 18, 2007
(86) PCT No.: PCT/AU2007/000684

§ 371 Date: Dec. 18, 2009

(30) Foreign Application Priority Data
May 18, 2006 (AU) 2006902685

(51) Int. Cl. G06Q 10/00; G06Q 30/00

(52) U.S. Cl. 705/10; 705/400; 705/28

(57) ABSTRACT

A method of managing inventory allocations includes the step of receiving, in a data processing apparatus, data relating to the sale of items of inventory allocated to respective re-sellers. The data is processed to obtain data relating to sales performance of one or more of the respective re-sellers. The method includes adjusting a price for which inventory allocated to that respective re-seller is to be sold by depending on said data relating to the sales performance of the respective re-sellers and/or re-allocating inventory items from that said respective re-seller to other respective re-sellers. The invention extends to a software product and to a system.

### FIELD OF THE INVENTION

This invention relates to the management of inventory allocations. More particularly, this invention relates to a system, to a method and to a software product for managing inventory allocations.

### BACKGROUND OF THE INVENTION

Applicant has identified a particular problem when selling inventory, such as travel services including accommodation allotments, flights and other transport services. The problem is a result of the manner in which such inventory is allocated to various re-sellers, referred to as distribution channels (“Channels”), which can be ad hoc and thus inefficient.

It will be appreciated that efficient selection of Channels for such inventory can allow vendors to achieve a selling price that corresponds with demand for the inventory in the Channels. In this way, an optimum price for, and supply of the inventory in each Channel could be achieved with such correct selection.

While this invention is intended to cover a wide variety of inventory-types, Applicant has discovered that particularly the travel and accommodation industries would benefit greatly from efficient allocations of inventory to various Channels. A primary reason for this is that the traveling public is now able to book and pay online for practically all of its travel and accommodation needs via various online travel/accommodation reseller portals and agencies, which can be regarded as Channels. The online reseller market is particularly large in this field and the various Channels have the potential to be extremely successful.

The particular problem discovered by the Applicant is that the market has forced vendors to commit physical inventory to particular Channels in a relatively ad hoc manner. Furthermore, where the inventory is accommodation which needs to be sold between particular dates, any attempt to achieve efficiency by selecting the most efficient Channels can become extremely difficult. In particular, Applicant has found that most independent hotels and accommodation properties lack the resources to have members of staff dedicated to managing allocations to Channels. Applicant has found that it is practically impossible for them to manage this inventory in multiple Channels while still maintaining their businesses.

### SUMMARY OF THE INVENTION

According to a first aspect of the invention, there is provided a method of managing inventory allocations, the method including the steps of:
receiving, in a data processing apparatus, data relating to the sale of items of inventory allocated to respective re-sellers;
processing, in the data processing apparatus, said data to obtain data relating to sales performance of at least one of said respective re-sellers; and
carrying out at least one of the following steps in the data processing apparatus:
   adjusting a price for which inventory allocated to at least that said respective re-seller is to be sold by that respective re-seller depending on said data relating to the sales performance of the respective re-sellers; and
   re-allocating inventory items from at least that said respective re-seller to other respective re-sellers.

The step of processing the data may include the step of calculating a performance indicator for each re-seller in the form of a function of a ratio of a number of items sold to the number of items allocated to the re-seller for sale.

The step of processing the data may include the step of comparing the performance indicator for a particular re-seller of inventory items to the performance indicators of other re-sellers of inventory items, the inventory items associated with respective re-sellers having at least one common characteristic.

The step of comparing the performance indicators may include the step of comparing the performance indicator of said particular re-seller to an average of the performance indicators of said other re-sellers.

The step of comparing the performance indicators may include the step of obtaining a percentage change (PC) of the performance indicator of said particular re-seller relative to said average of the performance indicators and applying the following equation to PC:

$${Z}_{j} = \frac{{PC}_{j} - Mean ( PC )}{St . Dev ( PC ) / \sqrt{n}} ,$$

where n is the number of re-sellers having said at least one common characteristic, j=1 to n, and Z is an adjustment rate to a price of the inventory item.

The method may include the step of adjusting a price of the inventory allocated to said particular re-seller by a factor of Z.

The step of processing said data may include the step of carrying out a statistical analysis of said data relating to sales performance.

According to a second aspect of the invention, there is provided a system for managing inventory allocations, the system including a data processing apparatus that is configured to carry out the following steps:
receiving data relating to the sale of items of inventory allocated to respective re-sellers;
processing said data to obtain data relating to sales performance of at least one of the respective re-sellers; and
carrying out at least one of the following steps:
   adjusting a price for which inventory allocated to at least that said respective re-seller is to be sold by that respective re-seller depending on said data relating to the sales performance of the respective re-sellers; and
   re-allocating inventory items from at least that said respective re-seller to other respective re-sellers.

The data processing apparatus may be configured to calculate a performance indicator for each re-seller in the form of a function of a ratio of a number of items sold to the number of items allocated to the re-seller for sale.

The data processing apparatus may be configured to compare the performance indicator for a particular re-seller of inventory items to the performance indicators of other re-sellers of inventory items, the inventory items associated with respective re-sellers having at least one common characteristic.

The data processing apparatus may be configured to compare the performance indicator of said particular re-seller to an average of the performance indicators of said other re-sellers.

The data processing apparatus may be configured to obtain a percentage change (PC) of the performance indicator of said particular re-seller relative to said average of the performance indicators and to apply the following equation to PC:

$${Z}_{j} = \frac{{PC}_{j} - Mean ( PC )}{St . Dev ( PC ) / \sqrt{n}} ,$$

where n is the number of re-sellers having said at least one common characteristic, j=1 to n, and Z is an adjustment rate to a price of the inventory item.

The data processing apparatus may be configured to adjust a price of the inventory allocated to said particular re-seller by a factor of Z.

The data processing apparatus may be configured to carry out a statistical analysis of said data relating to sales performance.

According to a third aspect of the invention, there is provided a software product for managing inventory allocations, the software product being executable by a data processing apparatus and being configured so that, when executed, the data processing apparatus carries out the following steps:
receives data relating to the sale of items of inventory allocated to respective re-sellers;
processes said data to obtain data relating to sales performance of at least one of said respective re-sellers; and
carries out at least one of the following steps:
   adjusts a price for which inventory allocated to at least that respective re-sellers is to be sold by that respective re-seller depending on said data relating to the sales performance of the respective re-sellers; and
   re-allocates inventory items from at least that said respective re-seller to other respective re-sellers.

The software product, when executed by a data processing apparatus, may cause the date processing apparatus to calculate a performance indicator for each re-seller in the form of a function of a ratio of a number of items sold to the number of items allocated to the re-seller for sale.

The software product, when executed by a data processing apparatus, may cause the data processing apparatus to compare the performance indicator for a particular re-seller of inventory items to the performance indicators of other re-sellers of inventory items, the inventory items associated with respective re-sellers having at least one common characteristic.

The software product, when executed by a data processing apparatus, may cause the data processing apparatus to compare the performance indicator of said particular re-seller to an average of the performance indicators of said other re-sellers.

The software product may, when executed by a the data processing apparatus, cause the data processing apparatus to obtain a percentage change (PC) of the performance indicator of said particular re-seller relative to said average of the performance indicators and to apply the following equation to PC:

$${Z}_{j} = \frac{{PC}_{j} - Mean ( PC )}{St . Dev ( PC ) / \sqrt{n}} ,$$

where n is the number of re-sellers having said at least one common characteristic, j=1 to n, and Z is an adjustment rate to a price of the inventory item.

The software product, when executed by a data processing apparatus, may cause the data processing apparatus to adjust a price of the inventory allocated to said particular reseller by a factor of Z.

The software product, when executed by a data processing apparatus, may cause the data processing apparatus to carry out a statistical analysis of said data relating to sales performance.

The invention is now described, by way of example, with reference to the accompanying drawings. The following description is intended to illustrate particular embodiments of the invention and to permit a person skilled in the art to put those embodiments of the invention into effect. Accordingly, the following description is not intended to limit the scope of the preceding paragraphs in any way.

### BRIEF DESCRIPTION OF THE DRAWINGS

In the drawings:

FIG. 1 shows a schematic view of an embodiment of a system, in accordance with the invention, for managing inventory allocations.

FIG. 2 shows a flowchart indicating one embodiment, in accordance with the invention, of a method and a software product for managing inventory allocations.

FIG. 3 shows a flowchart indicating a subroutine of the software product that is executed by a data processing apparatus of the system in the event that supply to a particular re-seller exceeds demand.

FIG. 4 shows a flowchart indicating a further subroutine of the software product for collecting data relating to different re-sellers.

FIG. 5 shows a schematic flowchart of another embodiment, in accordance with the invention, of a method and a software product for managing inventory allocations.

### DETAILED DESCRIPTION OF THE INVENTION

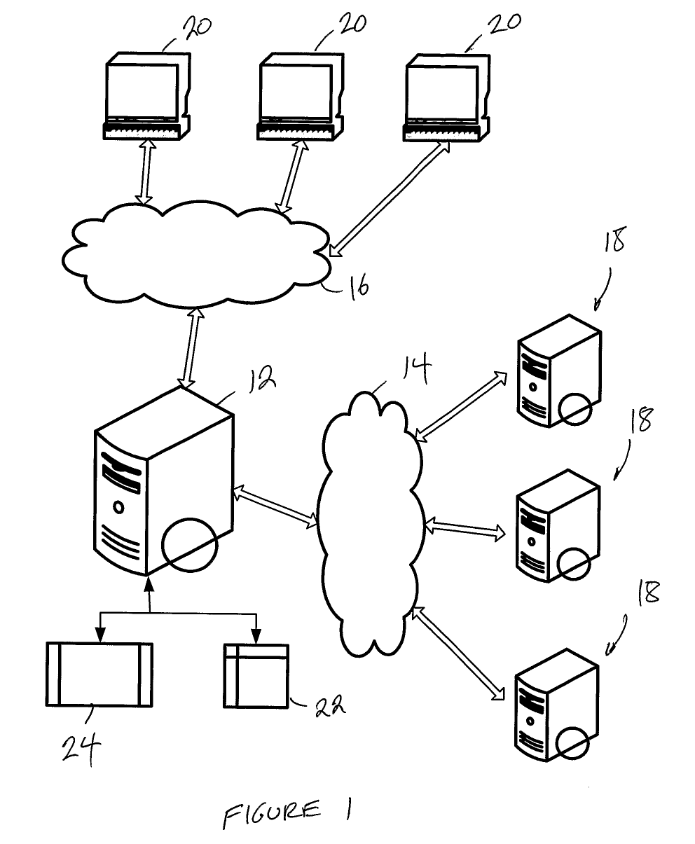

In FIG. 1, reference numeral 10 broadly illustrates an embodiment of a system, in accordance with the invention, for managing inventory allocated to respective re-sellers, according to an embodiment of a method, also in accordance with the invention.

At this point, it should be noted that FIG. 1 also broadly illustrates a system that encompasses the remaining embodiments of the system, all in accordance with the invention.

In the following description, reference is made to the inventory items in the form of accommodation allotments and in further descriptions as Rooms. It is to be understood that such accommodation allotments or Rooms are allotments of property for the purposes of short term rental, such as holiday apartments, hotel rooms, etc.

However, Applicant emphasizes that the items of inventory can be any other items which are capable of being allocated to a re-seller.

Accordingly, reference to accommodation allotments or “Rooms” is not to be construed as limiting the scope of the invention as set out in the preceding summary.

The system 10 includes a data processing apparatus in the form of a computer 12 that is connectable to a network. In this case, the network can be the Internet indicated at 14 or a private network indicated at 16. It will readily be appreciated that the private network 16 can be a virtually private network (VPN) which could form part of the World Wide Web indicated at 14.

The computer 12 is programmed with a software product, in accordance with the invention. As such, the computer 12 is configured to receive sale data relating to accommodation allotments allocated to respective re-sellers, referred to as distribution channels (“Channels”), indicated schematically at 18, via the World Wide Web 14. It is to be appreciated that the Channels 18 can more specifically be servers associated with the Channels 18. This is particularly the case where the Channels 18 are online re-sellers.

The software product is such that, when executed by the computer 12, the computer 12 is able to process the sale data to obtain data relating to sales performance in each Channel (Performance Data). On receipt of the Performance Data, the computer is configured to adjust the price of accommodation allotments in respective Channels 18 depending on the Performance Data and/or re-allocate accommodation allotments in respective Channels 18 to other Channels 18.

The computer 12 is configured to store data representing accommodation allotments (Accommodation Allotment Data) required to be sold online by third party online resellers through the Channels 18. The system 10 allows a vendor of the inventory, in the form of a member or subscriber, indicated at 20, to place all or part of their accommodation allotment inventory required to be sold online in a database 22 of the computer 12. Thus, the software product of the invention is configured so that, when executed, it generates a database 22 and a subroutine 24 to manipulate the Accommodation Allotment Data, as described below. In particular, the computer 12 is configured by the software to associate Channels 18 with accommodation allotments in the database 22. The computer 12 receives data relating to the sale of accommodation allotments (Sale Data) in the form of data relating to one or more of the following: sale price of each accommodation allotment, rate of commission and number of accommodation allotments sold over a pre-determined length of time. Subroutine 24 calculates an index (Sale Rate Index) for each Channel 18 in the form of a ratio of the number of accommodation allotments sold in a pre-determined time to the number of accommodation allotments available in that distribution channel 18 (“S”/“A”).

The computer processes the Sale Data by calculating a performance rating for each distribution channel 18. The performance rating can include a determination of whether or not supply of accommodation allotments exceeds demand or vice versa per Channel.

By using the performance rating and the calculated Sale Rate Index, S/A, the subroutine 24 can calculate the number of accommodation allotments to allocate to a particular Channel 18 and the price at which those allotments can be sold to maximize a profit for the accommodation allotments.

A particular benefit of the invention is that the subroutine 24 allows for the setting of a minimum rate and can adjust prices up from or back to that rate based on the Channel Performance in which the relevant accommodation allotment is placed. Thus, if an accommodation allotment is a room and the particular Channel 18 has a higher demand than availability, the subroutine can automatically increase the room rate to maximize profit.

Furthermore, the subroutine is configured also to increase the rate in Channels with a high selling rate and that have a high rate of agents' commission so that their performance rating can be equal to or higher than other Channels 18 with lower agents' commission. It follows that the system 10 can be used to maximize profit on a range of competing Channels. It follows also that a rate at which a particular Channel is selling compared to its performance rating is directly proportional to a surplus of supply and the rate at which the accommodation allotments are being sold in that channel.

It is to be understood that supply of accommodation allotments and extent of commission control, at a basic level, the rate at which an accommodation allotment is sold in each Channel 18. It follows that if a shortage of supply should occur, a price of accommodation allotments in all Channels 18 will increase. However, in the event that there is over-supply, the price will decrease relative to the performance rating.

It follows that the vendors or an administrator of the system of the invention can set a rate of change that could be used to increase or decrease a rate at which an accommodation allotment is sold. An example of a suitable rate is 10%. In a particular example, performance of the Channels 18 will be calculated per hour and related to previous statistical analysis of a particular targeted date range. That analysis can provide a tool for adjusting the rate upwardly or downwardly.

In the next embodiment described, there is provided a manner in which a suitable rate can be determined using a statistical equation. For the purposes of this example, it is assumed that a rate is set and subsequently adjusted as necessary.

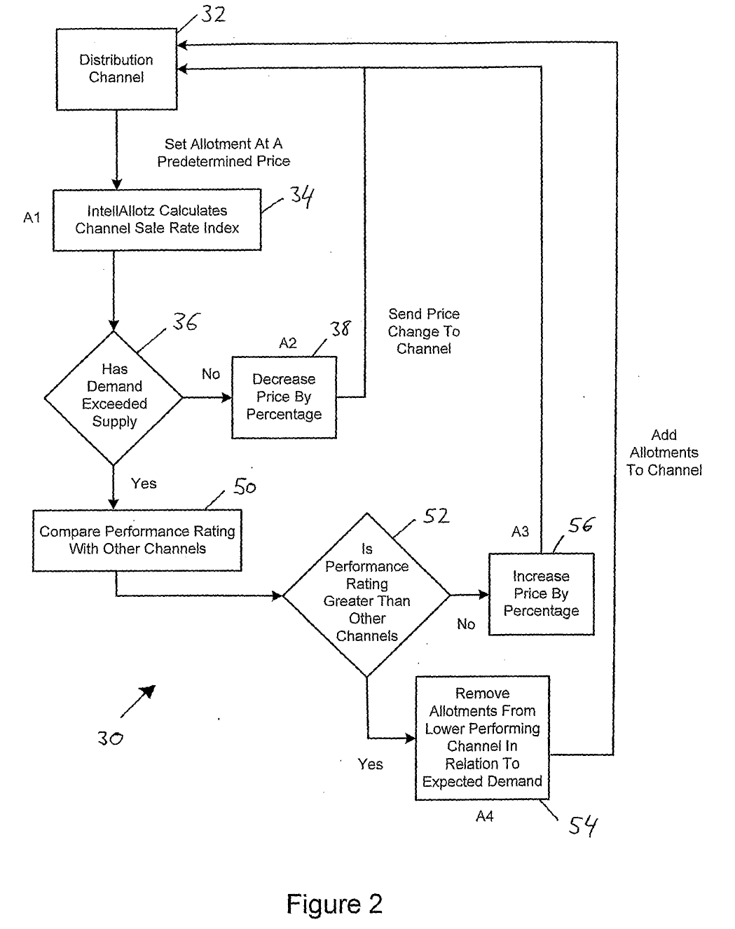

In FIG. 2, reference numeral 30 generally indicates a broad overview of the operation of the system 10 as a result of the execution of the software product of the invention.

In the system 30, reference numeral 32 indicates any Channel 18 in the form of a user-selected third party re-seller that stocks real-time property availabilities. The subroutine 24 is configured to utilize an XML standard to dynamically allocate or reallocate or update or query accommodation allotments associated with the Channel 32.

The system 30 is initiated with accommodation allotments being sold through the Channel 32 at a predetermined price. At 34, the subroutine 24 calculates a Sale Rate Index, as explained above. In particular, the subroutine 24 is configured to calculate the index by calculating an amount sold in a predetermined period of time divided by the amount allocated to that Channel (A/S). The value returned is then multiplied by 100 to get a percentage. The percentage is used as a parameter by the subroutine 24 to calculate whether or not particular Channels are allocated accommodation allotments. It will be appreciated that the parameter is used in a function to make that calculation. It will further be appreciated that Channels could be performing equally well, even though the value (NS) is higher for one than the other. This would occur where one of the Channels has been allocated more than the other.

In that case, imaginary accommodation allotments are made to equalize. Alternatively, a suitable statistical equation (described in more detail in the following embodiment) can be applied using a comparison to average values for A/S over the Channels being compared. The statistical equation can use a Standard Deviation parameter to adjust for the different starting amounts.

At 36, the subroutine 24 queries whether or not demand has exceeded supply in the Channel 32. If a negative answer is returned, the subroutine decreases the price by 10% at 38 and updates data representing the Channel 32.

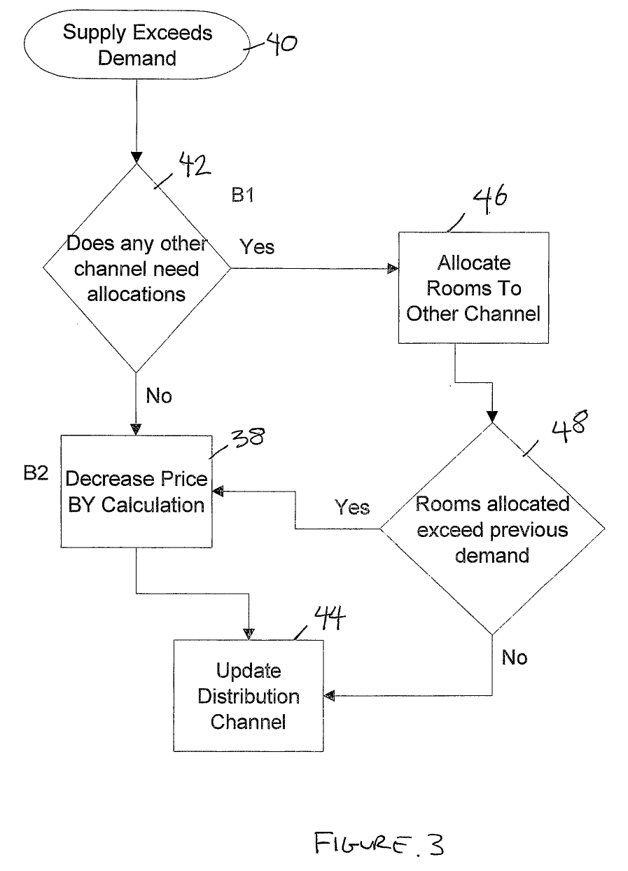

This step is more clearly shown in FIG. 3. In the event that supply exceeds demand at 40, the subroutine 24 queries at 42 whether any other Channel requires allocation of accommodation allotments. In the event that a negative answer is returned, the price can then be decreased as at 38. Once the price has been decreased, the subroutine 24 updates the data relating to the Channel 32, at 44.

In the event that the query at 42 is positive, the subroutine 24 allocates accommodation allotments, at 46, to another Channel. Subsequently, the subroutine 24 queries whether or not the rooms allocated to the other Channel exceed a previous demand at 48. In the event that that query returns a positive, the subroutine 24 carries out the step of decreasing the price, at 38. In the event that the query returns a negative, the Channel 32 is updated, as at 44.

The subroutine 24 includes a calculation at 38 that involves what is known as “Minimum Rack Rate”, a “Current Rate” and a “Surplus Percentage”. As is known in the accommodation industry, the term “rack rate” is used to refer to a fixed rate for a room. It follows that a Minimum Rack Rate would be a minimum price for a particular accommodation allotment. The current rate would be a rate at a particular snap shot in time. The Surplus Percentage would indicate a percentage of surplus accommodation allotments in a particular distribution channel.

The step of decreasing a price by the calculation at 38 is effectively a step of decreasing the performance rating of that particular channel. Accordingly, in this example, the subroutine 24 adjusts the performance rating down by 10%. Thus, if the Channel had a performance rating of X allotments selling at $Y each with a commission of $Z and the performance rating is to be reduced by 10%, the following calculation is carried out by the subroutine 24 to obtain the rate (R):

0.9X+Z=R

If the Minimum Rack Rate was below the R, then $R would be the new sale price per allotment. Otherwise, the minimum rack rate would be the price. It is thus to be appreciated that the subroutine 24 would not continually lower the prices of accommodation allotments beyond a predetermined minimum.

Reverting back now to FIG. 2, if the query at 36 returns a positive, the subroutine 24 compares the performance rating of the Channel 32 with other channels. As set out earlier, the performance rating can be in the form of a number of parameters. For example, it could be related to a surplus or deficit percentage related to supply and demand of particular accommodation allotments. At 52, the subroutine 24 queries whether or not the performance rating of the Channel 32 is greater than the other Channels. This can be done using the “imaginary rooms” or the statistical analysis mentioned above.

If the query returns a positive, the subroutine 24 removes accommodation allotments from the lower performing Channels and adds them to the Channel 32. Alternatively, if the query at 52 returns a negative result, the subroutine 24 serves to increase the accommodation allotment price by a particular percentage. In this case, the percentage is 10%.

Using a calculation similar to the one used for decreasing the price, if a Channel with a performance rate of X allotments selling at $Y with a commission of $Z is increased by 10% the following calculation would be used to obtain the rate (R):

1.1X+Z=R

As can be seen in FIG. 2, once the steps at 54 and 56 are completed, the subroutine 24 returns to 32 where the data relating to that Channel is updated.

It is important that the subroutine 24 collects the necessary data in an efficient manner.

Applicant has conceived two methods in which the data can be received from respective Channels 18. These are referred to as the “real-time” and “request-based” methods.

In this particular example, all calculations are done hourly per accommodation allotment and each allotment calculation is started apart from the others' calculations. It follows that property A calculations would for example start at 12:00 and property B calculations would start at 12:01 and so on. The subroutine 24 is configured such that the interval is decided by the amount of properties and servers on which the properties reside, where the servers communicate with the computer 12 via the World Wide Web 14. As set out above, the servers can also be represented by reference numeral 18.

Channels that report in real-time back to the subroutine 24 store their figures in the database 22 until they are needed by the subroutine 24. On the other hand, request-based Channels are polled by the subroutine 24 before the calculations are made.

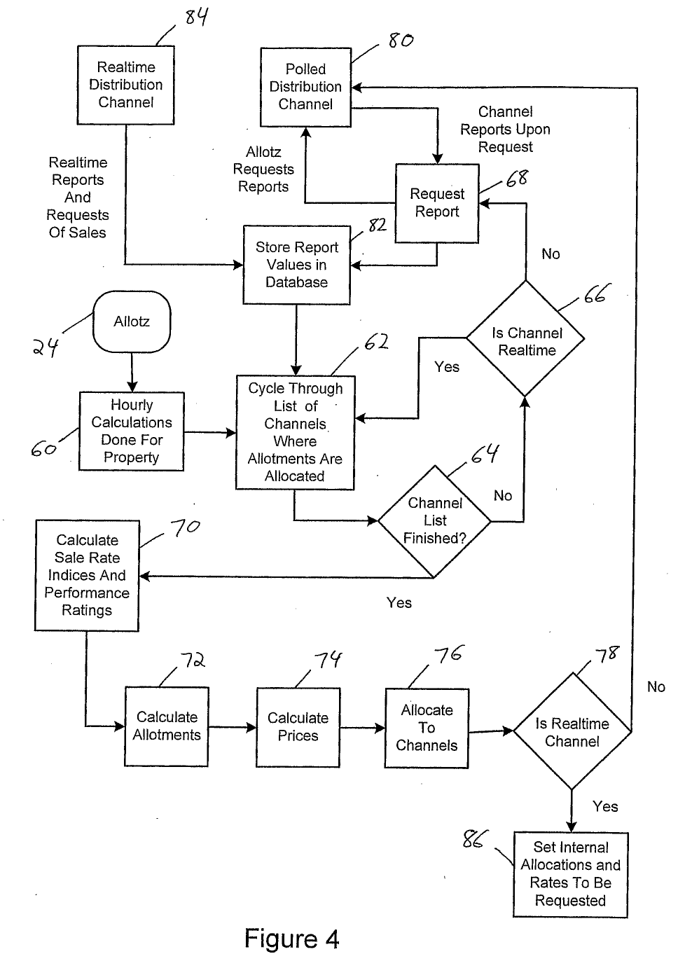

An example of the manner in which the figures are collected from servers for the Channels is shown in FIG. 4. In FIG. 4, the subroutine 24 carries out hourly calculations at 60 for each accommodation allotment in the various distribution channels. At the subroutine 24 cycles through a list of Channels where the accommodation allotments are stored in the data base 22.

The subroutine 24 then queries, at 64, whether or not the list of Channel has been cycled through. In the event that a negative response is returned, the subroutine 24 queries whether or not the Channel is “real-time”. In the event that the response is negative, the subroutine 24 requests a report at 68 from the relevant server. On the other hand, if the query at 66 is positive, the subroutine 24 continues to cycle through the list of Channels at 62.

If the query at 64 is positive, the subroutine 24 carries out various calculations to obtain the sale rate indices and performance rating, at 70, as described earlier. At 72, the allotments are calculated. At 74, the subroutine 24 calculates the prices for the accommodation allotments in the various Channels. At 76, the subroutine 24 allocates accommodation allotments to various Channels, in accordance with the tests and parameters described with reference to FIGS. 2 and 3. At 78, the subroutine 24 queries whether or not the respective Channel is a real-time Channel. In the event that this query returns a negative result, the subroutine 24 polls the relevant server of the Channel at 80. The server for the Channel then transmits the report to the database 22. The subroutine 24 stores the report values in the database 22 at 82.

At 84 there is schematically indicated a real-time Channel. The Channel 84 provides, on a regular basis, real-time reports and requests of sales to the data base at 82.

In the event that the query at 78 returns a positive, the subroutine 24 serves to re-set allocations of accommodation allotments to various Channels 18 and the respective prices at 86.

### Embodiment for Application Over a Predetermined Period

A further embodiment, in accordance with the invention, is now described with reference to an algorithm defined by the subroutine 24. The algorithm can be applied in the framework of the system 10, described above. However, this algorithm is an alternative to the algorithmic process described above, while still falling within the broader scope of the preceding material.

The description is with reference to the operation of the algorithm over a 5 day period. Reference is made to Tables 1 to 5 which appear at the end of the description of this embodiment. It is to be appreciated that the embodiment can readily be applied to longer or shorter periods without technical difficulty.

In this example, it is assumed that there are five Channels. This example takes into account that two of the Channels have negotiated blocks of 50 allotments, something which is conventional in the field. The negotiated blocks are indicated by the row entitled “blocked allocation” in the tables. It is to be understood that since those allotment allocations have been negotiated, it is not possible for the system 10 to act freely on those allocations.

For ease of reference only, the allotments are referred to as “Rooms”.

It should be noted that the Rooms are those associated with a particular property (Property). The Property is to be understood as a characteristic of the Rooms that makes comparison between the Rooms meaningful. For example, the Rooms could be sourced from a common hotel franchise or from a particular geographical area or from a particular star rating etc.

Set out below is a list of Notations used with their meanings in the Tables and in the following description:

| Notation | Definition |
|---|---|
| A | Number of Rooms Allotted |
| S | Number of Rooms Sold |
| I | An indicator variable to depict whether a Channel has a |
| | negotiated blocked allocation |
| T | Total Number of Rooms Sold |
| P | Proportion of Rooms Sold |
| NS_CR | Number of Rooms that are Not sold and CAN be redistributed |
| NS_CNR | Number Rooms that are Not sold and CANNOT be |
| | redistributed |
| TNS | Total Number of Rooms Not Sold |
| NAA | New Allocation Amount |
| Aadj | Allocation Adjustment Amount |
| FAA | Final Allocation Amount |
| RA | Redistribution Adjustment from Unblocked Rooms |
| FAA_UB | Final Allocation Amount After Unblocking |

The following totals are used throughout and are calculated over all the Channels during a predetermined time period:

| Notation | Definition |
|---|---|
| Sum_S | Total Rooms Sold Overall (per stated time period) |
| Sum_NSR | Total Rooms Not Sold (per time period) that |
| | CAN be redistributed |

If a blocked allocation of Rooms has been negotiated (i.e. it is not possible to transfer those Rooms from one Channel to another), wholesalers generally release unsold Rooms back to the associated Property, usually 7 days from the end of a negotiated time-period.

It is thus necessary to monitor each of the Rooms within each step of the algorithm to ensure that any adjustments are made using only those Rooms that are free to be sold through Channels and transferred from one Channel to another. The reason is that the blocked Rooms can be considered as sold.

This five day example assumes that on day four, any Rooms obtained in a previously negotiated blocked sale that are not sold are then released into a general domain for selling in any of the other Channels to sell, and re-allocated accordingly. This reallocation will be a function of a Channel's relative performance in the market.

Day 4 is therefore analogous to the start of a final 7-day period when rooms are released to the general domain as mentioned above.

Furthermore, it is assumed that adjustments are made only once a day.

For each Channel, the number of Rooms sold is recorded and a total is calculated in the final column. In order to obtain a measure of how well a re-seller is performing in the market, a ratio between the Rooms sold per Channel and the total number of Rooms sold at each time point is calculated. This provides a measure of how well a Channel is selling the Rooms for a predetermined time period. This is then used to ascertain any price adjustments that should be made for the associated Channel.

For j=1, n, where j represents the Channel Number, the ratio is defined by

$${P}_{j} = \frac{{S}_{j}}{{\sum }_{j = 1}^{n} {S}_{i}} , {S}_{j}$$

being the number sold per Channel. In this case, n=5.

In order to evaluate any redistribution of room allocations (when necessary), it is also necessary to record the number of rooms that are not sold. In general, if there are some Channels that have negotiated room blocks for a given room type in a given property (as is the case in this example), then this amount needs to be further broken down into a count of rooms that can be redistributed to other channels and a count of rooms that cannot be redistributed to other channels.

However, it is assumed that if a Room is sold from a Channel with a negotiated allocation, this will be deducted from their initial block of Rooms rather than any redistributed allocation that may occur at a stage when a Channel is depleted of all Rooms. This will be discussed in more detail below.

In order to set up the algorithm in the subroutine 24, Rooms are artificially allocated to each Channel depending on each P calculated above. This allocation is considered to be artificial since the main consideration is not whether a Channel is selling a large proportion of its Rooms, only that it is selling a larger proportion of Rooms relative to its competitors in that Property.

However, it is necessary for the number of Rooms to be factored into the algorithm used by the subroutine 24. The reason is that an accommodation provider can choose to allocate, at the outset, a block of Rooms (through negotiation based on a business decision) to a Channel or even select Channels through which to sell Rooms.

In any event, the following example illustrates why the number of Rooms should not play a role in price adjustments.

Assume there are only two Channels for Rooms in a particular Property. Assume that Channel 1 has 20 Rooms and Channel 2 has 10 Rooms and they each sell 5 Rooms. Comparatively, they are performing equally well, but if the price changes are based on a ratio of sold Rooms to allocated Rooms, then Channel 1 appears to be doing worse and its prices would be required to drop compared to Channel 2 that appears to be doing better and its prices would invariably go up.

Consequently, in order to calculate any price adjustments, the proportion of total Rooms sold by a Channel is compared to the average proportion over all Channels. This is done through a percentage change (PC) calculation relative to the average proportion of Rooms sold. Furthermore, a scale is derived to project these percentage changes onto a comparative measure, which is done in the following way:

$${Z}_{j} = \frac{{PC}_{j} - Mean ( PC )}{St . Dev ( PC ) / \sqrt{n}}$$

Again, the value for n should be replaced with 5 since five Channels are being considered. Using this, it is possible to apply the following adjustments:

| Z score | Adjustment to price |
|---|---|
| Greater than 3 | Increase by 5% |
| Between 2 and 3 | Increase by 2% |
| Between 1 and 2 | Increase by 1% |
| Between-1 and 1 | No change |
| Between-2 and -1 | Decrease by 1% |
| Between-3 and -2 | Decrease by 2% |
| Greater than -3 | Decrease by 5% |

The description given in the above paragraphs covers the general issues and calculations required to adjust the price of a Room for a respective Property.

The following paragraphs go into more detail regarding each step to be carried out in the algorithm and the order in which each of the steps must proceed.

Referring to the Tables mentioned earlier, Tables 1 to 4 are named “Base Case” and represent the situation on each day respectively when a given Channel that has no blocked Rooms is depleted of all of its inventory at the end of Day 1. Thus, a number of Rooms in the respective Channels needs to be adjusted.

Tables 5 to 8 are named “Inventory Depleted before Unblock” and represent the situation on each day respectively when a Channel is depleted of its Rooms on Day 2, prior to when its unsold Rooms in blocked Channels are released for general distribution.

Table 9 to 12 are named “Inventory Depleted after Unblock” and represent the situation when a Channel is depleted of its Rooms after any Rooms that have not been sold during the blocked period are released (on Day 4).

Three steps are to be noted when the subroutine 24 is executed. There are an initial set of steps for a first time period. These are described first. In a second and in subsequent time periods, a number of minor changes are applied depending on if and when Room numbers in respective Channels need to be readjusted. These are described in turn. Thirdly, prior to the blocked Rooms being released to the general domain, a number of steps are required to adjust the number of Rooms in respective Channels at the beginning of the next time period (i.e. at the beginning of Day 4 in this worked example).

Note that the notation used for logical statements in an Excel (such as If) are written below exactly as they would appear in an Excel spreadsheet, except that rather than using Cell Identifiers (for example, A1), a description of what the Cell contains, defined by the notation provided above, is given.

### Initial Steps to be Carried Out:

Per Channel, compute the following:
1. Record Rooms Allotted (A) and Rooms Sold (S).
2. If (I=1, NS_CNR=A−S, 0).
3. If (I=0, NS_CR=A−S, 0).
4. T=A−S.

Steps 2 and 3 ensure that those Rooms not sold are recorded correctly as to whether they can be redistributed at a later stage or not.

Next,
5. Calculate Sum_S and Sum_NSR using the values from the previous 4 steps.

Per Channel,
6. Calculate P as T/Sum_S.

Compare each of the amounts obtained at part 6 to the average proportion sold per Channel.
7. Compute the average of the P's.

Again, per Channel,
8. Work out the percentage change (% C) of each P relative to the average P.

Now, compute the average percentage change and the standard deviation of this percentage change (see equations above). Using these values, per Channel,
9. Subtract the mean Percentage Change from each % C; and;
10. Divide through by (Standard Deviation of the Percentage Change/Square Root (Number of Channels)).

This returns a Standardised Score for measuring each of the scores to each other and therefore adjusted according to the scales for Z provided above.

Per Channel, the subroutine 24 checks whether any Rooms need to be transferred to other Channels. This will only be the case if the Channel has sold all of its Rooms. Therefore,
11. Check to see if A>S. If so, then NAA=0 and there are still rooms left to sell for this Channel. If A=S, then multiply the proportion of rooms sold for this Channel (P) by Sum_NSR to get a value for NAA (this should only give a value for where A=S);
12. Compute any relevant adjustment of Room numbers for all other Channels (AAdj) by multiplying NS_CR by each P.
13. Compute the FAA at the next time period by adding AAdj to NS_CNR.

Note that Steps 12 and 13 only need to be carried out if one of the Channels has been depleted of Rooms. Furthermore, note that if a Room is transferred to another Channel and if a Channel has a Room block, it cannot have any Rooms taken away from it, but it is can be allocated more Rooms. However, this step is unavoidable since a transfer of Rooms is based on a ratio of Rooms sold per Channel to all Rooms sold and this total will include those blocked Channels and therefore cannot be ignored. However, any extra Rooms that are allocated to a blocked Channel can be redistributed if another Channel becomes depleted.

### Subsequent Steps to be Carried Out:

For further time periods, the following adjustments at steps 2 and 3 must be made:

### Per Channel,

at 2. If (I=1, NS_CNR=NS_CNR (Day 1) S (Day 2), 0). After the calculations for Day 1 have taken place initially, this becomes a count over each time period of how many Rooms from the original blocked count are available. Therefore, if (I=0), NS_CNR=0.

This next step ensures that if all of the Rooms from the block are sold (where it is assumed that if an accommodation provider has a blocked deal, then it will sell Rooms from that block first and then any other Rooms sold at a given time period will come out of its Rooms that CAN be redistributed, as mentioned above), and NS_CNR becomes negative in the step above, then this will not affect the calculation of the total Rooms not sold. The algorithm is capable of dealing with this. However, it means that the calculation for NS_CR must be altered so that the negative value does not affect totals that are otherwise correct.

### Consequently, per Channel,

at 3. If (NS_CNR>0, A−S−NS_CNR, A−S). Therefore, if NS_CNR is negative, the count of Rooms that have not yet been sold and that can be redistributed is simply (A−S) because all Rooms now are available to be redistributed. If NS_CNR is not negative, then the count of rooms that can be redistributed must be (A−S−NS_CNR) as there are still some available from the original blocked amount that cannot be classed as being able to be redistributed.

Note that in the initial loops (times when the algorithm is executed) performed by the subroutine using the algorithm, NS_CNR is unlikely to be negative because not many Rooms will be transferred and therefore, each Channel will keep selling Rooms from its initial allotted amount of Rooms.

However, it will be appreciated that a negative value for NS_CNR is possible since a blocked Channel can be allocated more Rooms when a transfer occurs and therefore sell its original blocked amount of Rooms while still having some Rooms left over to sell. As such, this step needs to be included so as to ensure that all totals are correct for sold and not sold Rooms and consequently prices are adjusted correctly.

### The Release of Unsold Blocked Rooms:

Assume that at Day 4 in this artificial example, any Rooms not sold from a block can be redistributed for ALL channels to sell. Therefore, prior to Day 4, at Step 11 a redistribution of the newly available Rooms must be made to all Channels, depending on how well they are currently performing in the market. Therefore, firstly per Channel,
11. A new row must be created that will convert any negative values of NS_CNR to zero. Recall that negative values in NS_CNR indicate that a Room sold has come from a count that CAN be redistributed rather than the blocked count. Next, calculate the total for this new row.
12. The remaining Rooms that have not been sold by the blocked channels can now be redistributed to all of the Channels depending on how well they are performing, measured through P. Therefore, multiply P by the total calculated in part 11 for each Channel. This is defined as RA.
13. Next, the Final Allocation Adjustment after Unblocking (FAA_UB) is determined. This is equal to RA+NS_CR for each Channel.
14. In defining the new Room totals per Channel, this new variable, FAA_UB will flow through into Day 4 to represent the new Room totals per Channel.

Note that after these blocked Rooms have been released, then the only total of Rooms not sold required is the absolute total per Channel and not the breakdown into those that can be redistributed and those that cannot. Therefore, there are two less rows after Day 4 in the tables in Excel.

Three Cases will now be described in more detail:

Three separate scenarios are described to consider a number of eventualities that are represented by the attached Tables.

### Tables 1 to 4: Base Case:

In this situation, the algorithm is configured so that only a Channel that has no blocked negotiations can have its Rooms to sell depleted. This is a case where the only complication arises when the total number of Rooms to be reallocated changes from those that can be redistributed to a different term in the spreadsheet after any unblocked Rooms are released into the general domain.

Therefore, prior to Day 4, steps 11 to 13 remain as described above. However, after Day 4, when checking for whether any Room transfers are necessary steps 11 to 13 are altered such that:
11. Check to see if A>S. If so, then NAA=0 and there are still Rooms left to sell for this Channel. If A=S, then multiply the proportion of Rooms sold per Channel (P) by TNS to get a value for NM (only for where A=S);
12. Lastly, compute the FAA at the next time period for all other channels by multiplying TNS by each P.
   Tables 9 to 12: Inventory Depleted after Unblock:

In this situation, the algorithm is configured for the case when a previously blocked Channel is depleted after the blocked Channels have redistributed their allocations (if they had not sold all of their allocations). Therefore, after Day 4, when checking for whether any Room transfers are necessary, steps 11 to 13 are changed slightly such that:
11. Check to see if A>S. If so, then NAA=0 and there are still Rooms left to sell for this Channel. If A=S, then multiply the proportion of Rooms sold per Channel (P) by TNS to get a value for NM (only for where A=S);
12. Lastly, compute the FAA at the next time period for all other Channels by multiplying TNS by each P.

### Tables 5 to 9: Inventory Depleted Before Unblock:

In this situation, the algorithm is configured for when a blocked Channel is depleted of its Rooms before the blocked Channels are required to redistribute their Rooms. Therefore, prior to Day 4, when checking for whether any Room transfers are necessary in steps 11 to 13, these are carried out in the same way as described in the initial step

The algorithm is preferably configured to make adjustments once a day. That serves to inhibit frequent fluctuations in price, which could occur in potentially large jumps upwards and/or downwards if the algorithm is used to update the prices more than once a day.

The time of day can be selected to take advantage of yield management theories indicating when a buyer is more likely to make a purchase of a Room over the Internet.

However, the situation arising as a result of a Channel selling all of its Rooms before re-adjustment would mean that the Channel could not sell any more Rooms until any re-adjustment takes place at the specified time.

For this eventuality, a loop is fed in to the algorithm to allow immediate updating and reallocation when a Channel sells all of its Rooms. Therefore, if S=A, then the algorithm updates immediately to reallocate some Rooms to that Channel to maintain the efficacy of the algorithm.

The algorithm is also configured to accommodate a situation where another Channel enters at any stage of a particular time-period. The algorithm incorporates a step that will allow for this to happen and each step in the algorithm can be generalised so that resulting calculations reflecting any new information entered as inputs are correct.

The invention is intended to cover an embodiment in which rather than using the number of Rooms sold to evaluate how a particular re-seller compares to its competitors, the total revenue generated out of the total amount of revenue for that time period is considered.

This can readily be implemented in the framework described in the above paragraphs, in the event that information was made available.

Furthermore, the invention is intended to cover an embodiment in which instead of making comparisons of Channels at time points, comparisons are made over a predetermined time period, 7 days, for example.

Still further, the invention provides a valuable opportunity to process data for the purposes of developing an evaluation tool. That could be done by recording historical data, analyzing the data statistically and monitoring the progress of the algorithm and of the market in general. This would inevitably lead to changes in the process described above and likely deliver a more efficient tool.

### A Further Example of a Calculation for Changing a Rate

The first calculation below determines the percentage of rooms booked via the channel out of rooms allocated to the channel for the property. This value is calculated for each day in a 30 day period assessed.

A=the total number of allotments given to the channel for the property per day
S=the number of total sold allotments via the channel for the property per day
Z1 to Z30=the percentage sold from a channel per day.

Z1=(A/S)×100

Z2=(A/S)×100

. . .

Z29=(A/S)×100

Z30=(A/S)×100

The second calculation below determines the average percentage of rooms sold over the entire 30 day period for that property via that channel.

M=Average percentage of rooms booked via that channel for the property over 30 days.

M=(Z1+Z2 . . . +Z29+Z30)/30

The next calculation determines how each day's percentage of rooms sold fair against the average percentage of rooms sold over the whole month. This will return a positive or negative number.

R1 to R30=a positive or negative number showing how a day's trade fairs against the monthly average of percentage of rooms sold.

R1=(Z1−M)

R2=(Z2−M)

R3=(Z3−M)

R4=(Z4−M)

. . .

R5=(Z4−M)

R6=(Z4−M)

The next calculation is designed to get the average number of rooms sold across all Channels using an embodiment of the invention for each day in the 30 day period assessed.

In the case of a property distributing to 3 Channels (i.e Channel 1, Channel 2 and Channel 3) the formula is:

C1=(Channel 1−Z1+Channel 2−Z1+Channel 3−Z1)/3

C2=(Channel 1−Z2+Channel 2−Z2+Channel 3−Z2)/3

. . .

C29=(Channel 1−Z29+Channel 2−Z29+Channel 3−Z29)/3

C30=(Channel 1−Z30+Channel 2−Z30+Channel 3−Z30)/3

The final calculation is done to determine the number (average percentage sold with controlling factors) between −100 and 100. This calculation is done for each day in the 30 day period assessed. This value is used to increase or decrease the rate according to a ledger of thresholds that can readily be determined by the Property.

N1=(C1+R1)/2

N2=(C2+R2)/2

. . .

N29=(C4+R4)/2

N30=(C5+R5)/2

TABLE 1
BASE CASE
Day 1

| Channel | Notation | C1 | C2 | C3 | C4 | C5 | Total | Av | Dev |
|---|---|---|---|---|---|---|---|---|---|
| Blocked Allocation | I | 1 | 1 | 0 | 0 | 0 | | | |
| Rooms Allotted | A | 50 | 50 | 50 | 50 | 50 | 250 | | |
| Room Sold | S | 8 | 20 | 50 | 10 | 5 | 93 | | |
| Rooms Not Sold (that cannot be | NS_CNR | 42 | 30 | 0 | 0 | 0 | 72 | | |
| redistributed) | | | | | | | | | |
| Rooms Not Sold (that can be | NS_CR | 0 | 0 | 0 | 40 | 45 | 85 | | |
| redistributed) | | | | | | | | | |
| Total Rooms Not Sold | TNS | 42 | 30 | 0 | 40 | 45 | 157 | | |
| Rooms Sold per Channel/Total | P | 0.086 | 0.2151 | 0.5376 | 0.1075 | 0.0538 | 1 | 0.2 | |
| Rooms Sold (P)** | | | | | | | | | |
| Percentage Difference in (P) | | −57 | 7.55 | 168.8 | −46.25 | −73.1 | | −2.8422E−15 | 99.0986 |
| (relative to average) | | | | | | | | | |
| Scaled Value | Z | −1.29 | 0.17 | 3.81 | −1.04 | −1.65 | | | |
| New Allocation Amount | NAA | 0 | 0 | 46 | 0 | 0 | 46 | | |
| New Allocation Adjustment | Aadj | 7 | 18 | 46 | 9 | 5 | 85 | | |
| Final Allocation Amount | FAA | 49 | 48 | 46 | 9 | 5 | 157 | | |

TABLE 2
BASE CASE
Day 2

| Channel | | C1 | C2 | C3 | C4 | C5 | Total | | |
|---|---|---|---|---|---|---|---|---|---|
| Rooms Allotted | A | 49 | 48 | 46 | 9 | 5 | 157 | | |
| Room Sold | S | 5 | 20 | 4 | 4 | 2 | 35 | | |
| Rooms Not Sold (that cannot be | NS_CNR | 37 | 10 | 0 | 0 | 0 | 47 | | |
| redistributed) | | | | | | | | | |
| Rooms Not Sold (that can be | NS_CR | 7 | 18 | 42 | 5 | 3 | 75 | | |
| redistributed) | | | | | | | | | |
| Total Rooms Not Sold | TNS | 44 | 28 | 42 | 5 | 3 | 122 | | |
| Rooms Sold per Channel/Total | P | 0.1429 | 0.5714 | 0.1143 | 0.1143 | 0.0571 | 1 | 0.2 | |
| Rooms Sold (P)** | | | | | | | | | |
| Percentage Difference in (P) | % C | −28.55 | 185.7 | −42.85 | −42.85 | −71.45 | | −5.6843E−15 | 104.973 |
| (relative to average) | | | | | | | | | |
| Scaled Value | Z | −0.64 | 4.19 | −0.97 | −0.97 | −1.61 | | | |
| New Allocation Amount | NAA | 0 | 0 | 0 | 0 | 0 | 0 | | |
| New Allocation Adjustment | Aadj | 0 | 0 | 0 | 0 | 0 | 0 | | |
| Final Allocation Amount | FAA | 0 | 0 | 0 | 0 | 0 | 0 | | |

TABLE 3
BASE CASE
Day 3

| Channel | | C1 | C2 | C3 | C4 | C5 | Total | | |
|---|---|---|---|---|---|---|---|---|---|
| Rooms Allotted | A | 44 | 28 | 42 | 5 | 3 | 122 | | |
| Room Sold | S | 10 | 4 | 2 | 2 | 2 | 20 | | |
| Rooms Not Sold (that cannot be | NS_CNR | 27 | 6 | 0 | 0 | 0 | 33 | | |
| redistributed) | | | | | | | | | |
| Indicator Variable for a | | 27 | 6 | 0 | 0 | 0 | 33 | | |
| negative number of rooms | | | | | | | | | |
| Rooms Not Sold (that can be | NS_CR | 7 | 18 | 40 | 3 | 1 | 69 | | |
| redistributed) | | | | | | | | | |
| Total Rooms Not Sold | TNS | 34 | 24 | 40 | 3 | 1 | 102 | | |
| Rooms Sold per Channel/Total | P | 0.5 | 0.2 | 0.1 | 0.1 | 0.1 | 1 | 0.2 | |
| Rooms Sold (P)** | | | | | | | | | |
| Percentage Difference in (P) | | 150 | 1.388E−14 | −50 | −50 | −50 | | 1.42109E−14 | 86.6025 |
| (relative to average) | | | | | | | | | |
| Scaled Value | Z | 3.38 | 0.00 | −1.13 | −1.13 | −1.13 | | | |
| New Allocation Amount | NAA | 0 | 0 | 0 | 0 | 0 | 0 | | |
| New Allocation Adjustment | Aadj | 0 | 0 | 0 | 0 | 0 | 0 | | |
| Final Allocation Amount | FAA | 0 | 0 | 0 | 0 | 0 | 0 | | |
| Redistribution adjustment from | RA | 17 | 7 | 3 | 3 | 3 | 33 | | |
| unblocked rooms | | | | | | | | | |
| Final Allocation Amount_After | FAA_UB | 24 | 25 | 43 | 6 | 4 | 102 | | |
| Unblocking | | | | | | | | | |

In this worked example, after this time point, blocked rooms have been redistributed

TABLE 4
BASE CASE

| | | | | | | |
|---|---|---|---|---|---|---|
| Channel | C1 | C2 | C3 | C4 | C5 | Total |

Day 4

| | | | | | | | | | |
|---|---|---|---|---|---|---|---|---|---|
| Rooms Allotted | A | 24 | 25 | 43 | 6 | 4 | 102 | | |
| Room Sold | S | 4 | 6 | 3 | 6 | 1 | 20 | | |
| Total Rooms Not Sold | TNS | 20 | 19 | 40 | 0 | 3 | 82 | | |
| Rooms Sold per Channel/Total | P | 0.2 | 0.3 | 0.15 | 0.3 | 0.05 | 1 | 0.2 | |
| Rooms Sold (P)** | | | | | | | | | |
| Percentage Difference in (P) | | 0 | 50 | −25 | 50 | −75 | | −8.5265E−15 | 53.033 |
| (relative to average) | | | | | | | | | |
| Scaled Value | Z | 0.00 | 1.13 | −0.56 | 1.13 | −1.69 | | | |
| New Allocation Amount | NAA | 0 | 0 | 0 | 25 | 0 | 25 | | |
| Final Allocation Amount | FAA | 16 | 25 | 12 | 25 | 4 | 82 | | |

Day 5

| | | | | | | | | | |
|---|---|---|---|---|---|---|---|---|---|
| Rooms Allotted | A | 16 | 25 | 12 | 25 | 4 | 82 | | |
| Room Sold | S | 10 | 0 | 2 | 2 | 1 | 15 | | |
| Total Rooms Not Sold | TNS | 6 | 25 | 10 | 23 | 3 | 67 | | |
| Rooms Sold per Channel/Total | P | 0.6667 | 0 | 0.1333 | 0.1333 | 0.0667 | 1 | 0.2 | |
| Rooms Sold (P)** | | | | | | | | | |
| Percentage Difference in (P) | | 233.35 | −100 | −33.35 | −33.35 | −66.65 | | 8.52651E−15 | 133.341 |
| (relative to average) | | | | | | | | | |
| Scaled Value | Z | 5.27 | −2.26 | −0.75 | −0.75 | −1.50 | | | |
| New Allocation Amount | NAA | 0 | 0 | 0 | 0 | 0 | 0 | | |
| New Allocation Adjustment | Aadj | 0 | 0 | 0 | 0 | 0 | 0 | | |
| Would stop here in this example | | | | | | | | | |

TABLE 5
INVENTORY DEPLETED BEFORE UNBLOCK
Day 1

| Channel | Notation | C1 | C2 | C3 | C4 | C5 | Total | Av. | Dev |
|---|---|---|---|---|---|---|---|---|---|
| Blocked Allocation | I | 1 | 1 | 0 | 0 | 0 | | | |
| Rooms Allotted | A | 50 | 50 | 50 | 50 | 50 | 250 | | |
| Room Sold | S | 8 | 20 | 8 | 10 | 5 | 51 | | |
| Rooms Not Sold | NS_CNR | 42 | 30 | 0 | 0 | 0 | 72 | | |
| (that cannot be | | | | | | | | | |
| redistributed) | | | | | | | | | |
| Rooms Not Sold | NS_CR | 0 | 0 | 42 | 40 | 45 | 127 | | |
| (that can be | | | | | | | | | |
| redistributed) | | | | | | | | | |
| Total Rooms Not | TNS | 42 | 30 | 42 | 40 | 45 | 199 | | |
| Sold | | | | | | | | | |
| Rooms Sold per | P | 0.1569 | 0.3922 | 0.1569 | 0.1961 | 0.098 | 1.0001 | 0.20002 | |
| Channel/Total | | | | | | | | | |
| Rooms Sold (P)** | | | | | | | | | |
| Percentage | | −21.557844 | 96.080392 | −21.557844 | −1.959804 | −51.0049 | | −1.3E−14 | 56.4939457 |
| Difference in (P) | | | | | | | | | |
| (relative to | | | | | | | | | |
| average) | | | | | | | | | |
| Scaled Value | Z | −0.85 | 3.80 | −0.85 | −0.08 | −2.02 | | | |
| New Allocation | NAA | 0 | 0 | 0 | 0 | 0 | 0 | | |
| Amount | | | | | | | | | |
| New Allocation | Aadj | 0 | 0 | 0 | 0 | 0 | 0 | | |
| Adjustment | | | | | | | | | |
| Final Allocation | FAA | 0 | 0 | 0 | 0 | 0 | 0 | | |
| Amount | | | | | | | | | |

TABLE 6
INVENTORY DEPLETED BEFORE UNBLOCK
Day 2

| Channel | | C1 | C2 | C3 | C4 | C5 | Total | | |
|---|---|---|---|---|---|---|---|---|---|
| Rooms Allotted | A | 42 | 30 | 42 | 40 | 45 | 199 | | |
| Room Sold | S | 5 | 20 | 4 | 4 | 2 | 35 | | |
| Rooms Not Sold | NS_CNR | 37 | 10 | 0 | 0 | 0 | 47 | | |
| (that cannot be | | | | | | | | | |
| redistributed) | | | | | | | | | |
| Rooms Not Sold | NS_CR | 0 | 0 | 38 | 36 | 43 | 117 | | |
| (that can be | | | | | | | | | |
| redistributed) | | | | | | | | | |
| Total Rooms Not | TNS | 37 | 10 | 38 | 36 | 43 | 164 | | |
| Sold | | | | | | | | | |
| Rooms Sold per | P | 0.1429 | 0.5714 | 0.1143 | 0.1143 | 0.0571 | 1 | 0.2 | |
| Channel/Total | | | | | | | | | |
| Rooms Sold (P)** | | | | | | | | | |
| Percentage | % C | −28.55 | 185.7 | −42.85 | −42.85 | −71.45 | | −5.7E−15 | 104.972544 |
| Difference in (P) | | | | | | | | | |
| (relative to | | | | | | | | | |
| average) | | | | | | | | | |
| Scaled Value | Z | −1.13 | 7.35 | −1.70 | −1.70 | −2.83 | | | |
| New Allocation | NAA | 0 | 0 | 0 | 0 | 0 | 0 | | |
| Amount | | | | | | | | | |
| New Allocation | Aadj | 0 | 0 | 0 | 0 | 0 | 0 | | |
| Adjustment | | | | | | | | | |
| Final Allocation | FAA | 0 | 0 | 0 | 0 | 0 | 0 | | |
| Amount | | | | | | | | | |

TABLE 7
INVENTORY DEPLETED BEFORE UNBLOCK
Day 3

| Channel | | C1 | C2 | C3 | C4 | C5 | Total | | |
|---|---|---|---|---|---|---|---|---|---|
| Rooms Allotted | A | 37 | 10 | 38 | 36 | 43 | 164 | | |
| Room Sold | S | 10 | 4 | 2 | 2 | 2 | 20 | | |
| Rooms Not Sold | NS_CNR | 27 | 6 | 0 | 0 | 0 | 33 | | |
| (that cannot be | | | | | | | | | |
| redistributed) | | | | | | | | | |
| Indicator Variable | | 27 | 6 | 0 | 0 | 0 | 33 | | |
| for a negative | | | | | | | | | |
| number of rooms | | | | | | | | | |
| Rooms Not Sold | NS_CR | 0 | 0 | 36 | 34 | 41 | 111 | | |
| (that can be | | | | | | | | | |
| redistributed) | | | | | | | | | |
| Total Rooms Not | TNS | 27 | 6 | 36 | 34 | 41 | 144 | | |
| Sold | | | | | | | | | |
| Rooms Sold per | P | 0.5 | 0.2 | 0.1 | 0.1 | 0.1 | 1 | 0.2 | |
| Channel/Total | | | | | | | | | |
| Rooms Sold (P)** | | | | | | | | | |
| Percentage | | 150 | 1.388E−14 | −50 | −50 | −50 | | 1.42E−14 | 86.6025404 |
| Difference in (P) | | | | | | | | | |
| (relative to | | | | | | | | | |
| average) | | | | | | | | | |
| Scaled Value | Z | 5.94 | 0.00 | −1.98 | −1.98 | −1.98 | | | |
| New Allocation | NAA | 0 | 0 | 0 | 0 | 0 | 0 | | |
| Amount | | | | | | | | | |
| New Allocation | Aadj | 0 | 0 | 0 | 0 | 0 | 0 | | |
| Adjustment | | | | | | | | | |
| Final Allocation | FAA | 0 | 0 | 0 | 0 | 0 | 0 | | |
| Amount | | | | | | | | | |
| Redistribution | RA | 17 | 7 | 3 | 3 | 3 | 33 | | |
| adjustment from | | | | | | | | | |
| unblocked rooms | | | | | | | | | |
| Final Allocation | FAA_UB | 17 | 7 | 39 | 37 | 44 | 144 | | |
| Amount_After | | | | | | | | | |
| Unblocking | | | | | | | | | |

In this worked example, after this time point, blocked rooms have been redistributed

TABLE 8
INVENTORY DEPLETED BEFORE UNBLOCK

| | | | | | | |
|---|---|---|---|---|---|---|
| Channel | C1 | C2 | C3 | C4 | C5 | Total |

Day 4

| | | | | | | | | | |
|---|---|---|---|---|---|---|---|---|---|
| Rooms Allotted | A | 17 | 7 | 39 | 37 | 44 | 144 | | |
| Room Sold | S | 17 | 6 | 3 | 2 | 1 | 29 | | |
| Total Rooms Not | TNS | 0 | 1 | 36 | 35 | 43 | 115 | | |
| Sold | | | | | | | | | |
| Rooms Sold per | P | 0.5862 | 0.2069 | 0.1034 | 0.069 | 0.0345 | 1 | 0.2 | |
| Channel/Total | | | | | | | | | |
| Rooms Sold (P)** | | | | | | | | | |
| Percentage | | 193.1 | 3.45 | −48.3 | −65.5 | −82.75 | | 0 | 112.661234 |
| Difference in (P) | | | | | | | | | |
| (relative to | | | | | | | | | |
| average) | | | | | | | | | |
| Scaled Value | Z | 7.64 | 0.14 | −1.91 | −2.59 | −3.28 | | | |
| New Allocation | NAA | 67 | 0 | 0 | 0 | 0 | 67 | | |
| Amount | | | | | | | | | |
| Final Allocation | FAA | 67 | 24 | 12 | 8 | 4 | 115 | | |
| Amount | | | | | | | | | |

Day 5

| | | | | | | | | | |
|---|---|---|---|---|---|---|---|---|---|
| Rooms Allotted | A | 67 | 24 | 12 | 8 | 4 | 115 | | |
| Room Sold | S | 10 | 18 | 2 | 2 | 1 | 33 | | |
| Total Rooms Not | TNS | 57 | 6 | 10 | 6 | 3 | 82 | | |
| Sold | | | | | | | | | |
| Rooms Sold per | P | 0.303 | 0.5455 | 0.0606 | 0.0606 | 0.0303 | 1 | 0.2 | |
| Channel/Total | | | | | | | | | |
| Rooms Sold (P)** | | | | | | | | | |
| Percentage | | 51.5 | 172.75 | −69.7 | −69.7 | −84.85 | | −1.1E−14 | 111.142381 |
| Difference in (P) | | | | | | | | | |
| (relative to | | | | | | | | | |
| average) | | | | | | | | | |
| Scaled Value | Z | 2.04 | 6.84 | −2.76 | −2.76 | −3.36 | | | |
| New Allocation | NAA | 0 | 0 | 0 | 0 | 0 | 0 | | |
| Amount | | | | | | | | | |
| New Allocation | Aadj | 0 | 0 | 0 | 0 | 0 | 0 | | |
| Adjustment | | | | | | | | | |

TABLE 9
INVENTORY DEPLETED AFTER UNBLOCK
Day 1

| Channel | Notation | C1 | C2 | C3 | C4 | C5 | Total | Av. | Dev |
|---|---|---|---|---|---|---|---|---|---|
| Blocked Allocation | I | 1 | 1 | 0 | 0 | 0 | | | |
| Rooms Allotted | A | 50 | 50 | 50 | 50 | 50 | 250 | | |
| Room Sold | S | 8 | 20 | 8 | 10 | 5 | 51 | | |
| Rooms Not Sold | NS_CNR | 42 | 30 | 0 | 0 | 0 | 72 | | |
| (that cannot be | | | | | | | | | |
| redistributed) | | | | | | | | | |
| Rooms Not Sold | NS_CR | 0 | 0 | 42 | 40 | 45 | 127 | | |
| (that can be | | | | | | | | | |
| redistributed) | | | | | | | | | |
| Total Rooms Not | TNS | 42 | 30 | 42 | 40 | 45 | 199 | | |
| Sold | | | | | | | | | |
| Rooms Sold per | P | 0.1569 | 0.3922 | 0.1569 | 0.1961 | 0.098 | 1.0001 | 0.20002 | |
| Channel/Total | | | | | | | | | |
| Rooms Sold (P)** | | | | | | | | | |
| Percentage | | −21.557844 | 96.080392 | −21.557844 | −1.959804 | −51.0049 | | −1.3E−14 | 56.4939457 |
| Difference in (P) | | | | | | | | | |
| (relative to | | | | | | | | | |
| average) | | | | | | | | | |
| Scaled Value | Z | −0.85 | 3.80 | −0.85 | −0.08 | −2.02 | | | |
| New Allocation | NAA | 0 | 0 | 0 | 0 | 0 | 0 | | |
| Amount | | | | | | | | | |
| New Allocation | Aadj | 0 | 0 | 0 | 0 | 0 | 0 | | |
| Adjustment | | | | | | | | | |
| Final Allocation | FAA | 0 | 0 | 0 | 0 | 0 | 0 | | |
| Amount | | | | | | | | | |

TABLE 10
INVENTORY DEPLETED AFTER UNBLOCK
Day 2

| Channel | | C1 | C2 | C3 | C4 | C5 | Total | | |
|---|---|---|---|---|---|---|---|---|---|
| Rooms Allotted | A | 42 | 30 | 42 | 40 | 45 | 199 | | |
| Room Sold | S | 5 | 20 | 4 | 4 | 2 | 35 | | |
| Rooms Not Sold | NS_CNR | 37 | 10 | 0 | 0 | 0 | 47 | | |
| (that cannot be | | | | | | | | | |
| redistributed) | | | | | | | | | |
| Rooms Not Sold | NS_CR | 0 | 0 | 38 | 36 | 43 | 117 | | |
| (that can be | | | | | | | | | |
| redistributed) | | | | | | | | | |
| Total Rooms Not | TNS | 37 | 10 | 38 | 36 | 43 | 164 | | |
| Sold | | | | | | | | | |
| Rooms Sold per | P | 0.1429 | 0.5714 | 0.1143 | 0.1143 | 0.0571 | 1 | 0.2 | |
| Channel/Total | | | | | | | | | |
| Rooms Sold (P)** | | | | | | | | | |
| Percentage | % C | −28.55 | 185.7 | −42.85 | −42.85 | −71.45 | | −5.7E−15 | 104.972544 |
| Difference in (P) | | | | | | | | | |
| (relative to | | | | | | | | | |
| average) | | | | | | | | | |
| Scaled Value | Z | −1.13 | 7.35 | −1.70 | −1.70 | −2.83 | | | |
| New Allocation | NAA | 0 | 0 | 0 | 0 | 0 | 0 | | |
| Amount | | | | | | | | | |
| New Allocation | Aadj | 0 | 0 | 0 | 0 | 0 | 0 | | |
| Adjustment | | | | | | | | | |
| Final Allocation | FAA | 0 | 0 | 0 | 0 | 0 | 0 | | |
| Amount | | | | | | | | | |

TABLE 11
INVENTORY DEPLETED AFTER UNBLOCK
Day 3

| Channel | | C1 | C2 | C3 | C4 | C5 | Total | | |
|---|---|---|---|---|---|---|---|---|---|
| Rooms Allotted | A | 37 | 10 | 38 | 36 | 43 | 164 | | |
| Room Sold | S | 10 | 4 | 2 | 2 | 2 | 20 | | |
| Rooms Not Sold | NS_CNR | 27 | 6 | 0 | 0 | 0 | 33 | | — |
| (that cannot be | | | | | | | | | |
| redistributed) | | | | | | | | | |
| Indicator Variable | | 27 | 6 | 0 | 0 | 0 | 33 | | |
| for a negative | | | | | | | | | |
| number of rooms | | | | | | | | | |
| Rooms Not Sold | NS_CR | 0 | 0 | 36 | 34 | 41 | 111 | | |
| (that can be | | | | | | | | | |
| redistributed) | | | | | | | | | |
| Total Rooms Not | TNS | 27 | 6 | 36 | 34 | 41 | 144 | | |
| Sold | | | | | | | | | |
| Rooms Sold per | P | 0.5 | 0.2 | 0.1 | 0.1 | 0.1 | 1 | 0.2 | |
| Channel/Total | | | | | | | | | |
| Rooms Sold (P)** | | | | | | | | | |
| Percentage | | 150 | 1.388E−14 | −50 | −50 | −50 | | 1.42E−14 | 86.6025404 |
| Difference in (P) | | | | | | | | | |
| (relative to | | | | | | | | | |
| average) | | | | | | | | | |
| Scaled Value | Z | 5.94 | 0.00 | −1.98 | −1.98 | −1.98 | | | |
| New Allocation | NAA | 0 | 0 | 0 | 0 | 0 | 0 | | |
| Amount | | | | | | | | | |
| New Allocation | Aadj | 0 | 0 | 0 | 0 | 0 | 0 | | |
| Adjustment | | | | | | | | | |
| Final Allocation | FAA | 0 | 0 | 0 | 0 | 0 | 0 | | |
| Amount | | | | | | | | | |
| Redistribution | RA | 17 | 7 | 3 | 3 | 3 | 33 | | |
| adjustment from | | | | | | | | | |
| unblocked rooms | | | | | | | | | |
| Final Allocation | FAA_UB | 17 | 7 | 39 | 37 | 44 | 144 | | |
| Amount_After | | | | | | | | | |
| Unblocking | | | | | | | | | |

In this worked example, after this time point, blocked rooms have been redistributed

TABLE 12
INVENTORY DEPLETED AFTER UNBLOCK

| | | | | | | |
|---|---|---|---|---|---|---|
| Channel | C1 | C2 | C3 | C4 | C5 | Total |

Day 4

| | | | | | | | | | |
|---|---|---|---|---|---|---|---|---|---|
| Rooms Allotted | A | 17 | 7 | 39 | 37 | 44 | 144 | | |
| Room Sold | S | 17 | 6 | 3 | 2 | 1 | 29 | | |
| Total Rooms Not | TNS | 0 | 1 | 36 | 35 | 43 | 115 | | |
| Sold | | | | | | | | | |
| Rooms Sold per | P | 0.5862 | 0.2069 | 0.1034 | 0.069 | 0.0345 | 1 | 0.2 | |
| Channel/Total | | | | | | | | | |
| Rooms Sold (P)** | | | | | | | | | |
| Percentage | | 193.1 | 3.45 | −48.3 | −65.5 | −82.75 | | 0 | 112.661234 |
| Difference in (P) | | | | | | | | | |
| (relative to | | | | | | | | | |
| average) | | | | | | | | | |
| Scaled Value | Z | 7.64 | 0.14 | −1.91 | −2.59 | −3.28 | | | |
| New Allocation | NAA | 67 | 0 | 0 | 0 | 0 | 67 | | |
| Amount | | | | | | | | | |
| Final Allocation | FAA | 67 | 24 | 12 | 8 | 4 | 115 | | |
| Amount | | | | | | | | | |

Day 5

| | | | | | | | | | |
|---|---|---|---|---|---|---|---|---|---|
| Rooms Allotted | A | 67 | 24 | 12 | 8 | 4 | 115 | | |
| Room Sold | S | 10 | 18 | 2 | 2 | 1 | 33 | | |
| Total Rooms Not | TNS | 57 | 6 | 10 | 6 | 3 | 82 | | |
| Sold | | | | | | | | | |
| Rooms Sold per | P | 0.303 | 0.5455 | 0.0606 | 0.0606 | 0.0303 | 1 | 0.2 | |
| Channel/Total | | | | | | | | | |
| Rooms Sold (P)** | | | | | | | | | |
| Percentage | | 51.5 | 172.75 | −69.7 | −69.7 | −84.85 | | −1.1E−14 | 111.142381 |
| Difference in (P) | | | | | | | | | |
| (relative to | | | | | | | | | |
| average) | | | | | | | | | |
| Scaled Value | Z | 2.04 | 6.84 | −2.76 | −2.76 | −3.36 | | | |
| New Allocation | NAA | 0 | 0 | 0 | 0 | 0 | 0 | | |
| Amount | | | | | | | | | |
| New Allocation | Aadj | 0 | 0 | 0 | 0 | 0 | 0 | | |
| Adjustment | | | | | | | | | |

### Embodiment for Application without a Predetermined Period

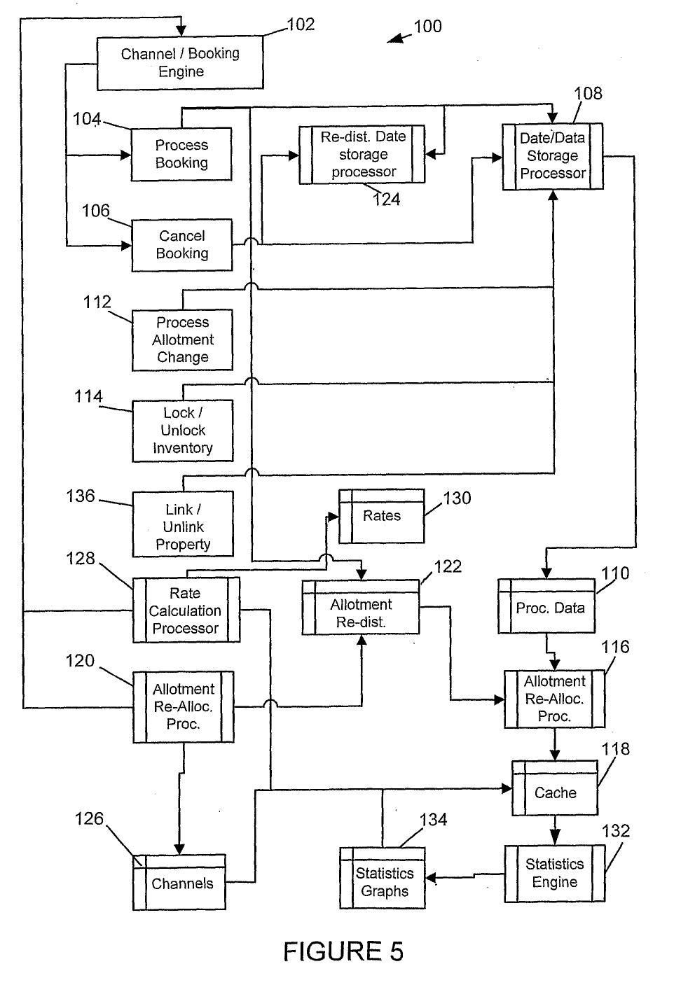

The following paragraphs relate to the schematic flowchart set out in FIG. 5 and referred to generally with reference numeral 100. The schematic flowchart 100 represents an embodiment, in accordance with the invention, of a software product and a method for managing inventory allocated to respective re-sellers. In particular, when executed by a data processing apparatus exemplified by the data processing apparatus or computer 12, the product provides flexibility in the application of the generated performance indicator referred to with the variable Z in the previous embodiment to current and future “Yield Management” techniques (i.e. techniques relating to maximizing the financial yield from inventory allocations).

In the following description, the variable symbols used correspond with those defined in the description of the previous embodiment, unless otherwise indicated.

The software product 100 is also configured to separate various processes and calculations into stages to limit the amount of processing needed when applying the indicator (Z) to “Yield Management” techniques and to cache the data for appropriate re-use (e.g. statistical analysis). This allows operations to be performed on the indicator without the need to calculate it every time.

For convenience, the allocation of inventory will be referred to as a Room, with the understanding that this embodiment can be applied to any allocation of inventory. Furthermore, the Rooms can be associated with a particular property to envisage the situation of, for example, a resort attempting to obtain the best yield from the Rooms it has available. “Property” could also be understood to be more than particular geographical location. For example, it could be a certain category of properties, or a chain of resorts. In other words, the Rooms are grouped into Properties to provide a meaningful comparison between performances achieved by different Channels.

Each logical progression is numbered and explained below and refers to the program flow depicted by FIG. 5.

### Processes Initiated by a Channel/Booking Engine

The software product 100 defines a remote booking engine 102 that uses a suitable communications protocol to receive booking data at 104 for a property and room type when made via a Channel.

The remote booking engine 102 is configured to receive cancellation data at 106 for a property and a room type when made via a Channel.

Processes that Feed Data into a Data Storage Function.

When a booking is processed and the booking data is entered into the system, the software product 100 calls a data storage function 108 for storing the booking data in a Data Processing Table 110. The function 108 writes an appropriate date range (arrival date and departure date less one day) and associated room identification data (Room ID) to the table 110.

When a cancellation is processed at 106, the software product 100 calls the function 108 for storing a record in the table 110. The function 108 stores the date and Room ID in the table 110.

Allocation allotment changes are processed at 112 in a suitable allotment interface. The function 108 is called and the appropriate date range (Date Range) and associated Room ID is passed to the function 108 which stores the Date Range and Room ID in the table 110. If more than one Room is chosen for allocation changes then more than one record of the change is created in the table 110.

It will be understood that certain Rooms in a particular property could be locked or unlocked from processing by the software product 100 due to a previous negotiation with a specific Channel, as envisaged in the previous embodiment. When Rooms for a Channel are locked or unlocked at 114 via an interface referred to as a Channel Connection Interface, a section of the Rooms available on a given date for the associated Channel is removed from or added to a re-distribution pool of Rooms by the function 108. When this occurs, all cached records for Rooms from an associated property are re-calculated based on a resultant re-distributable pool. The appropriate date ranges (from a day the Rooms are locked until a last allotment date for that Property), as well as all the Room ID's for that Property, are passed to the function 108 which stores the records in the table 110.

Calculating a Performance Indicator from the Data Processing Table

This is a process that runs constantly. Steps 1 and 2 below are repeated as long as there is data to select from the table 110.
1. The records are selected by a function 116 consecutively from the table 110 in the order of entry.
2. An algorithm defined by the function 116 is then processed for each day and associated Room ID in the date range stored in the table 110.

A difference between this embodiment and the previous embodiment for a predetermined timeline is that a concept of a “re-distribution timeline” (the five days in the Tables) is not introduced at this stage. This means that a value of “Sum_A” only includes the allotments from Channels participating in the re-distribution process for a Room Type (i.e. a Room in a particular Property) and date of a particular record.

In order to participate in this embodiment, a Channel must not be holding blocked inventory. Also the Channel must at least have an “allotment value” for the Room via the Channel on the given date in the record. An “allotment value” is an entry in a database table used by the product 100 to associate Channels with Rooms, Room types, available dates and other characteristics usually associated with a booking.

“Sum_NSR” therefore only includes rooms that are sold from a re-distributable pool.

Per Channel, the function 116 computes the following:
1. Record Rooms Allotted (A) and Rooms Sold (S).
2. NS_R=A−S (The C is dropped since C & CN are indicators of whether or not a particular Room can be sold, as that differentiator is not applicable in this embodiment).
3. T=A−S.

### Next,

4. Calculate Sum_S and Sum_NSR using the values from the previous 3 steps.

### Per Channel,

5. Calculate P as S/Sum_S.

Now, the function 116 compares each of the amounts obtained at step 5 to the average proportion sold per Channel.
6. Compute the average of the P's.

### Again, per Channel,

7. Compute a percentage change (% C) of each P relative to the average P.
8. Compute the average percentage change and the standard deviation of this percentage change.
   Using these values, per Channel,
9. Subtract the mean Percentage Change from each % C; and;
10. Divide the result returned by the previous step through by (Standard Deviation of the Percentage Change)(Square Root (Number of Channels)).

The results of these calculations are then recorded or updated for each date processed and for each Channel that has a Room allocated on the respective date, for the Room Type being processed, into a cache table 118.

### Re-Distributing Rooms Triggered by Booking and Cancellation Processes

When the booking processing is complete and it has been calculated that a Channel has run out of Rooms for a Room Type then an Allotment Re-Distribution Date Storage function 120 is called to store the Room ID and date where re-allocation is required into an Allotment Re-Distribution Table 122.

If it is determined that there are no more Rooms to re-distribute for a particular Room ID and date then the data is not entered into the table 122 as no re-distribution is required.

When the cancellation processing is complete and a new Room exists for the Room Type then an Allotment Re-Distribution Date Storage function 124 is called to store the Room ID and date where re-allocation is required in the table 122.

Each record is selected from the table 122 and processed by the function 122 one by one in order of entry into the table 122.

The Channels that participate in a re-distribution process described above for a particular Room Type and date are selected from a Channels table 126. To satisfy “participation” criteria they must not be holding inventory that is “locked” in the Channel. They must also at least have an allotment value, as described above for the Room via the Channel on the given date. In other words there must be an entry in the table 126 that associates the Channel and the Room.

They must also be currently linked to the Property via an active ClientChannels table record. An active ClientChannels table record is a record in a ClientChannels table that links to an interface used by a vendor to select a particular Channel. Thus, the table record contains a list of Channels available for selection by the vendor. In order for the particular record to be active, that Channel should have been selected by a vendor to participate in the reselling of the vendor's inventory (Rooms for this particular example). It will be appreciated that “vendor” is used broadly and can be interchanged with “Property” as that word has been defined earlier.

Once the participant Channels have been determined, the function 120 uses the performance indicator (Z) for the Channel, to order a list in the Channel table 126 from highest performing Channel first to lowest performing Channel last. If there are Channels in the list that have the same performance rating then the function 120 uses a randomizing algorithm to order those Channels.

After the order has been determined, the function 120 counts the number of Rooms in the re-distributable pool for the day in question and loops through the list of Channels assigning one Room to each channel in the list in turn until the number of re-distributable Rooms is exhausted. If the list of Channels is exhausted and there are still Rooms to be distributed the looping process is repeated until there are no more Rooms to distribute.

Once a count of Rooms to be allotted has been determined, the function 120 generates the necessary script to facilitate allotment with OTA XML and communicates it to the Channels via the protocol used by OTA. OTA stands for the Open Travel Alliance. That organisation has developed an XML standard (OTA XML) that facilitates online bookings and allocations.

### Price Modification

A price or rate calculation function 128 is called and executed every 24 hours by a time-based scheduling device or cron. The function 128 adjusts prices for 30 days into the future from the date on which it is executed for all Channels that have rooms with allotments on the days in question.

The function 128 initiates by uploading a list of the dates to process. Next it selects all the Room and Channel combinations from the table 122 that actually have an allotment value for the respective dates. The allotment value must be greater than 0 as there is no reason to increase the price of a room if there is nothing to sell.

Then it selects a performance indicator Z for a Room and Channel combination from the cache 118.

The function 128 then selects a current price for the room via that Channel on the date it is executed as well as a minimum rate (the rate it cannot go below) for that date/Room/Channel combination.

It then carries out an adjustment on the rate according to Z and the corresponding adjustment value from an adjustment table referred to in the previous embodiment making sure it does not drop below the minimum rate.

A Rates table 130 is then adjusted accordingly and the OTA XML created for transfer of the respective rate to the Channel.

### Linking and Unlinking Rooms

At 136, the software product 100 provides an interface to permit the Property to lock inventory (Rooms) out of the algorithms of the software product in the event that a Property has negotiated a block of the Rooms with a particular vendor. in the event that Rooms are to be released back for participation in the software product 100, the interface 100 allows the Rooms to be “unlocked”.

### Statistical Analysis

A particular advantage of the invention is that it provides the cache 118 that is accessible with a statistical analysis engine 132. The engine 132 is configured to perform statistical analyses on the data collected in the cache 118 to assess the performance of the algorithms used by the software product of the invention.

The statistical assessment can be carried out manually. However, it is preferable that the assessment be carried out with a suitable application such as that known as a genetic or self-learning algorithm.

In order to achieve that, a statistics table 134 is provided to receive data from the statistical analysis engine 132.

Applicant believes that the invention provides a means whereby a highly efficient distribution of inventory such as accommodation allotments can be made between various distribution channels for that inventory. This is particularly important in the online reseller market where property holders are simply not in a position to investigate the performance of various distribution channels. In short, the invention provides a means whereby the accommodation allotment resellers can simply subscribe to a provider of the invention in return for having their inventory or accommodation allotments sold as efficiently as possible.

It is to be understood that the present invention, in accordance with at least one presently preferred embodiment, includes a system for managing inventory allocations, a method of managing inventory allocations, and a software product for managing inventory allocations. Together, these elements may be implemented on at least one general-purpose computer running suitable computer programs including the preferred embodiment of the software product. They may also be implemented on at least one integrated circuit or part of at least one integrated circuit. Thus, it is to be understood that the invention may be implemented in hardware, software, or a combination of both.

Although illustrative embodiments of the present invention have been described herein with reference to the accompanying drawings, it is to be understood that the invention is not limited to those precise embodiments, and that various other changes and modifications may be affected therein by one skilled in the art without departing from the scope or spirit of the invention.

1-21. (canceled)

22. A method of managing inventory allocations, the method including the steps of:
receiving, in a data processing apparatus, data relating to the sale of inventory allotments allocated to respective re-sellers;
processing, in the data processing apparatus, said data to obtain data relating to sales performance of at least one of said respective re-sellers by calculating a performance indicator for each re-seller in the form of at least one function that includes a ratio of a number of allotments sold to at least one of a number of allotments allocated to the re-seller for sale and a number of allotments available for sale by the re-seller; and
carrying out at least the following steps in the data processing apparatus:
adjusting a price for which inventory allotments allocated to at least that said respective re-seller is to be sold by that respective re-seller; and
re-allocating inventory allotments to or from at least that said respective re-seller respectively from or to other respective re-sellers depending on said data relating to the sales performance of the respective re-sellers.

23. A method as claimed in claim 22, in which said at least one function includes a ratio of a number of allotments sold in a predetermined time period to at least one of a number of allotments allocated to the re-seller for sale and a number of allotments available for sale by the re-seller.

24. A method as claimed in claim 22, in which the step of processing the data includes the step of comparing the performance indicator for a particular re-seller to the performance indicators of other re-sellers, the inventory allotments associated with respective re-sellers having at least one common characteristic.

25. A method as claimed in claim 24, in which the step of comparing the performance indicators includes the step of comparing the performance indicator of said particular re-seller to an average of the performance indicators of said other re-sellers.

26. A method as claimed in claim 25, in which the step of comparing the performance indicators includes the step of obtaining a percentage change (PC) of the performance indicator of said particular re-seller relative to said average of the performance indicators and applying the following equation to PC:
$${Z}_{j} = \frac{{PC}_{j} - Mean ( PC )}{St . Dev ( PC ) / \sqrt{n}} ,$$
where n is the number of re-sellers having said at least one common characteristic, j=1 to n, and Z is an adjustment rate to a price of the inventory allotment.

27. A method as claimed in claim 26, which includes the step of adjusting a price of the inventory allotments allocated to said particular re-seller by a factor of Z.

28. A method as claimed in claim 22, in which the step of processing said data includes the step of carrying out a statistical analysis of said data relating to sales performance.

29. A system for managing inventory allocations, the system including a data processing apparatus that is configured to carry out the following steps:
receiving data relating to the sale of inventory allotments allocated to respective re-sellers;
processing, in the data processing apparatus, said data to obtain data relating to sales performance of at least one of said respective re-sellers by calculating a performance indicator for each re-seller in the form of at least one function that includes a ratio of a number of allotments sold to at least one of a number of such allotments allocated to the re-seller for sale and a number of allotments available for sale by the re-seller; and
carrying out at least the following steps in the data processing apparatus:
adjusting a price for which inventory allotments allocated to at least that said respective re-seller is to be sold by that respective re-seller; and
re-allocating inventory allotments to or from at least that said respective re-seller respectively from or to other respective re-sellers depending on said data relating to the sales performance of the respective re-sellers.

30. A system as claimed in claim 29, in which said at least one function includes a ratio of a number of allotments sold in a predetermined time period to at least one of a number of allotments allocated to the re-seller for sale and a number of allotments available for sale by the re-seller.

31. A system as claimed in claim 29, in which the data processing apparatus is configured to compare the performance indicator for a particular re-seller to the performance indicators of other re-sellers, the inventory allotments associated with respective re-sellers having at least one common characteristic.

32. A system as claimed in claim 29, in which the data processing apparatus is configured to compare the performance indicator of said particular re-seller to an average of the performance indicators of said other re-sellers.

33. A system as claimed in claim 32, in which the data processing apparatus is configured to obtain a percentage change (PC) of the performance indicator of said particular re-seller relative to said average of the performance indicators and to apply the following equation to PC:
$${Z}_{j} = \frac{{PC}_{j} - Mean ( PC )}{St . Dev ( PC ) / \sqrt{n}} ,$$
where n is the number of re-sellers having said at least one common characteristic, j=1 to n, and Z is an adjustment rate to a price of the inventory allotment.

34. A system as claimed in claim 33, in which the data processing apparatus is configured to adjust a price of the inventory allotment allocated to said particular re-seller by a factor of Z.

35. A system as claimed in claim 29, in which the data processing apparatus is configured to carry out a statistical analysis of said data relating to sales performance.

36. A software product for managing inventory allocations, the software product being executable by a data processing apparatus and being configured so that, when executed, the data processing apparatus carries out the following steps:
receives, in a data processing apparatus, data relating to the sale of inventory allotments allocated to respective re-sellers;
processes, in the data processing apparatus, said data to obtain data relating to sales performance of at least one of said respective re-sellers by calculating a performance indicator for each re-seller in the form of at least one function that includes a ratio of a number of allotments sold to at least one of a number of allotments allocated to the re-seller for sale and a number of allotments available for sale by the re-seller; and
carries out at least the following steps in the data processing apparatus:
adjusts a price for which inventory allotments allocated to at least that said respective re-seller is to be sold by that respective re-seller; and
re-allocates inventory allotments to or from at least that said respective re-seller respectively from or to other respective re-sellers depending on said data relating to the sales performance of the respective re-sellers.

37. A software product as claimed in claim 36, in which said at least one function includes a ratio of a number of allotments sold in a predetermined time period to at least one of a number of allotments allocated to the re-seller for sale and a number of allotments available for sale by the re-seller.

38. A software product as claimed in claim 36, which, when executed by a data processing apparatus, causes the data processing apparatus to compare the performance indicator for a particular re-seller to the performance indicators of other re-sellers, the inventory allotments associated with respective re-sellers having at least one common characteristic.

39. A software product as claimed in claim 36, which, when executed by a data processing apparatus, causes the data processing apparatus to compare the performance indicator of said particular re-seller to an average of the performance indicators of said other re-sellers.

40. A software product as claimed in claim 39, which, when executed by the data processing apparatus, causes the data processing apparatus to obtain a percentage change (PC) of the performance indicator of said particular re-seller relative to said average of the performance indicators and to apply the following equation to PC:
$${Z}_{j} = \frac{{PC}_{j} - Mean ( PC )}{St . Dev ( PC ) / \sqrt{n}} ,$$
where n is the number of re-sellers having said at least one common characteristic, j=1 to n, and Z is an adjustment rate to a price of the inventory allotment.

41. A software product as claimed in claim 40, which, when executed by a data processing apparatus, causes the data processing apparatus to adjust a price of the inventory allotment allocated to said particular re-seller by a factor of Z.

42. A software product as claimed in claim 36, which, when executed by a data processing apparatus, causes the data processing apparatus to carry out a statistical analysis of said data relating to sales performance.
